(19) United States
(12) Patent Application Publication
(10) Pub. No.: US 2023/0097716 A1
(43) Pub. Date: Mar. 30, 2023

(54) Authenticating Individuals Based on Game Decisions and Behaviors

(71) Applicant: FiveGen, LLC, Las Vegas, NV (US)

(72) Inventor: Sam McMullen, V, Las Vegas, NV (US)

(73) Assignee: FiveGen, LLC, Las Vegas, NV (US)

(21) Appl. No.: 17/485,326

(22) Filed: Sep. 25, 2021

(51) Int. Cl. A63F 13/71; A63F 13/79; A63F 13/213; H04L 9/32; H04L 9/08; G06N 3/04; G06N 3/08

(52) U.S. Cl. CPC A63F 13/71; A63F 13/79; A63F 13/213; H04L 9/3231; H04L 9/0825; H04L 9/0869; G06N 3/0454; G06N 3/08; A63F 2300/532

(57) ABSTRACT

A computer that performs authentication is described. During operation, the computer may receive an authentication request associated with an individual playing a video game. In response to the authentication request, the computer may obtain game information associated with current play of the video game by the individual and second game information associated with one or more prior instances of the individual playing the video game. Then, the computer may determine the authentication of the individual based at least in part on the game information and the second game information. Next, the computer may selectively allow the individual to continue to play the video game based at least in part on the authentication.

### FIELD

The described embodiments relate to techniques for authenticating an individual. Notably, the described embodiments relate to authenticating individuals based at least in part on game decisions and behaviors of the individual.

### BACKGROUND

A variety of techniques are used to authenticate users. For example, the identity of a user may be confirmed or verified using: password-based authentication, multi-factor authentication, certificate-based authentication, biometric authentication, token-based authentication, etc. When a user is properly authenticated, a trust relationship may be established so that they may be allowed to access data, resources or applications.

While many authentication techniques can provide strong authentication, there are often difficulties associated with many authentication techniques. For examples, a user may have trouble remembering a strong password. Consequently, the user may choose a simple password that is easier to remember, but is also easier to break or hack.

Moreover, it can be difficult to manage and disseminate certificates and tokens to users. Furthermore, biometric authentication may pose privacy and security concerns. Notably, once biometric data (such as a fingerprint, an ear image or an iris scan) has been compromised, there typically is no way to repair the damage. In addition, some users may not have a particular biometric identifier (such as a fingerprint).

### SUMMARY

In a first group of embodiments, a computer that selectively provides a recommendation is described. This computer includes: an interface circuit that communicates with an electronic device; a processor coupled to the interface circuit; and memory, coupled to the processor, that stores program instructions, where, when executed by the processor, the program instructions cause the computer to perform operations. Notably, during operation, the computer obtains game information associated with one or more video games played by an individual, where the game information specifies decisions and behaviors in the one or more video games while the individual played the one or more video games. Then, the computer computes, for the individual, scores for a set of predefined attributes associated with occupations based at least in part on the decisions and/or the behaviors. Next, the computer selectively provides the recommendation based at least in part on the computed scores, where the recommendation is associated with: an academic area of study for the individual, an employment opportunity for the individual, and/or an occupation for the individual.

Note that the game information may correspond to one or more types of events during a given video game in the video games. For example, the one or more types of events may include: a time to perform a task in a given video game when given a directive (or an instruction); a reaction time to a change in a state of a given video game; a mistake by the individual; and/or an instance of cheating by the individual based at least in part on instructions or a briefing associated with the given video game. Moreover, the game information may include: titles of the one or more video games, types of the one or more video games, genres of the one or more video games, a number of times a given video game was played, assists to at least another player by the individual during the one or more video games, deaths of the individual in the one or more video games, kills by the individual in the one or more video games, wins by the individual in the one or more video games, and/or losses by the individual in the one or more video games.

Furthermore, the operations may include obtaining monitoring data of the individual while the individual played the one or more video games. This monitoring data may specify or may include at least one of: physiological data of the individual, a gaze direction of the individual, eye motion of the individual, a posture of the individual, fidgeting of the individual, user-interface actions of the individual, and/or a type of facial expression of the individual.

Additionally, the game information may be predetermined and the obtaining may include accessing the game information in memory. Alternatively or additionally, the obtaining may include measuring the game information while the individual plays the one or more video games.

In some embodiments, the operations may include aggregating game information of multiple individuals for the one or more video games, and the computing of the scores may include comparing the game information of the individual to the aggregated game information of the multiple individuals or one or more moments of at least a distribution corresponding to the aggregated game information of the multiple individuals.

Note that the computing of the scores may be based at least in part on temporal patterns of the decisions and the behaviors.

Moreover, the decisions and the behaviors may include or correspond to at least one of actions taken or potential actions not taken during the one or more video games.

Furthermore, the operations may include: selectively requesting that the individual repeat playing of one or more of the video games based at least in part on confidence intervals of one or more of the scores of one or more of the predefined attributes in the set of predefined attributes; obtaining additional game information associated with the repeated playing of the one or more video games, where the additional game information specifies additional decisions and additional behaviors in the repeated playing of the one or more video games while the individual repeated playing of the one or more video games; and computing, for the individual, revised scores for the one or more predefined attributes based at least in part on the additional decisions and/or the additional behaviors. The selective providing of the recommendation may be further based at least in part on the computed revised scores.

Additionally, the request may be based at least in part on an output of a pretrained machine-learning model or a pretrained neural network.

In some embodiments, the set of predefined attributes may include categories of occupational information. These categories of occupational information may include one or more of: worker characteristics, worker requirements, worker experience, worker skills, and/or occupational requirements associated with different occupations. For example, the categories of occupational information may include occupation information network (O*NET) data.

Note that the set of predefined attributes may be different from personality types or a personality assessment.

Another embodiment provides the electronic device.

Another embodiment provides a computer-readable storage medium for use with the computer or the electronic device. When executed by the computer or the electronic device, this computer-readable storage medium causes the computer or the electronic device to perform at least some of the aforementioned operations.

Another embodiment provides a method, which may be performed by the computer or the electronic device. This method includes at least some of the aforementioned operations.

In a second group of embodiments, a computer that performs authentication is described. This computer includes: an interface circuit that communicates with an electronic device; a processor coupled to the interface circuit; and memory, coupled to the processor, that stores program instructions, where, when executed by the processor, the program instructions cause the computer to perform operations. Notably, during operation, the computer receives an authentication request associated with an individual playing a video game. In response to the authentication request, the computer obtains game information associated with current play of the video game by the individual and second game information associated with one or more prior instances of the individual playing the video game. Then, the computer determines the authentication of the individual based at least in part on the game information and the second game information. Next, the computer selectively allows the individual to continue to play the video game based at least in part on the authentication.

Note that the determining of the authentication may be based at least in part on a location of an electronic device associated with the individual.

Moreover, the authentication request may include an identifier of an electronic device associated with the individual and the determining of the authentication may be based at least in part on the identifier. For example, the identifier may include a media access control (MAC) address or an Internet Protocol (IP) address.

Furthermore, the authentication request may include an encrypted value associated with the individual and the determining the authentication may be based at least in part on the encrypted value. This encrypted value may be based at least in part on a predefined alphanumeric value. For example, the predefined alphanumeric value may include a random number or a pseudorandom number. Alternatively or additionally, the authentication request may include an alphanumeric value and the encrypted value may correspond to the alphanumeric value, and the operations may include: calculating a second encrypted value based at least in part on the alphanumerical value and a predefined encryption key associated with the individual; and comparing the encrypted value and the second encrypted value, where the determining of the authentication is based at least in part on the comparison.

Additionally, the authentication request may include a biometric identifier of the individual and the determining the authentication may be based at least in part on the biometric identifier.

In some embodiments, the game information and the second game information may specify decisions and behaviors of the individual in the video game while the individual is playing or played the video game. Alternatively or additionally, the game information and the second game information may specify interactions in the video game with another player while the individual and the other player play or played the video game. Moreover, the game information and the second game information may include monitoring data of the individual while the individual is playing or played the video game. This monitoring data may specify or include at least one of: physiological data of the individual, a gaze direction of the individual, eye motion of the individual, a posture of the individual, fidgeting of the individual, user-interface actions of the individual, and/or a type of facial expression of the individual.

Furthermore, the determining of the authentication may be based at least in part on an output of a pretrained machine-learning model or a pretrained neural network.

Additionally, the operations may include linking an identity of the authenticated individual to a virtual object or an attribute obtained in an environment of the video game. In some embodiments, the identity may be transferrable to a third party or another individual. Note that the attribute may include: a skill, or an achievement. Moreover, the identity may be immutable.

Furthermore, the operations may include linking a second identity of the authenticated individual to the game information and/or the second game information. This second identity may be the same as or different from the identity. In some embodiments, the second identity may be transferrable to a third party or another individual. Note that the second identity may be immutable.

Another embodiment provides the electronic device.

Another embodiment provides a computer-readable storage medium for use with the computer or the electronic device. When executed by the computer, this computer-readable storage medium causes the computer or the electronic device to perform at least some of the aforementioned operations.

Another embodiment provides a method, which may be performed by the computer or the electronic device. This method includes at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in a system in accordance with an embodiment of the present disclosure.

FIG. 2 is a flow diagram illustrating an example of a method for selectively providing a recommendation using a computer in FIG. 1 in accordance with an embodiment of the present disclosure.

FIG. 3 is a drawing illustrating an example of communication between the computer and an electronic device in FIG. 1 in accordance with an embodiment of the present disclosure.

FIG. 4 is a drawing illustrating an example of selectively providing a recommendation to an individual in accordance with an embodiment of the present disclosure.

FIG. 5 is a flow diagram illustrating an example of a method for performing authentication using a computer in FIG. 1 in accordance with an embodiment of the present disclosure.

FIG. 6 is a drawing illustrating an example of communication between the computer and an electronic device in FIG. 1 in accordance with an embodiment of the present disclosure.

FIG. 7 is a drawing illustrating an example of performing authentication of an individual in accordance with an embodiment of the present disclosure.

FIG. 8 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In a first group of embodiments, a computer that selectively provides a recommendation is described. During operation, the computer may obtain game information associated with one or more video games played by an individual, where the game information specifies decisions and behaviors in the one or more video games while the individual played the one or more video games. Then, the computer may compute, for the individual, scores for a set of predefined attributes associated with occupations based at least in part on the decisions and/or the behaviors. Next, the computer may selectively provide the recommendation based at least in part on the computed scores, where the recommendation is associated with: an academic area of study for the individual, an employment opportunity for the individual, and/or an occupation for the individual.

By mapping the decisions and behaviors of the individual to the set of predefined attributes, these recommendation techniques may provide improved skills assessment of the individual. Notably, the skills assessment may be conducted in a non-intrusive manner using normal activities of the individual, such as playing one or more video games. Moreover, this approach may not ‘gamify’ the skills assessment. Instead, the determination or learning of the scores for the individual may occur using one or more video games that the individual chooses to play and that are, per se, customized or developed to reflect or assess the predefined attributes. Therefore, the individual may not need to disrupt their normal activities (such as playing the one or more video games) to perform a time-consuming skills assessment, and the results obtained using the recommendation techniques may not be biased. Consequently, the recommendation(s) selectively provided by the recommendation techniques may have improved accuracy, and may be more useful or beneficial for the individual.

In a second group of embodiments, a computer that performs authentication is described. During operation, the computer may receive an authentication request associated with an individual playing a video game. In response to the authentication request, the computer may obtain game information associated with current play of the video game by the individual and second game information associated with one or more prior instances of the individual playing the video game. Then, the computer may determine the authentication of the individual based at least in part on the game information and the second game information. Next, the computer may selectively allow the individual to continue to play the video game based at least in part on the authentication.

By authenticating the individual based at least in part on the signatures or patterns provided by their game information (such as their decisions and behaviors while playing the video game and the one or more prior instances of playing the video game), these authentication techniques may provide accurate, dynamic and non-intrusive authentication. Notably, the individual may not need to create and memorized a strong password. Moreover, there may not be a need to manage and disseminate a certificate or a token. Furthermore, the authentication may be based at least in part on dynamic information (e.g., that varies as the individual plays different video games or that can evolve as a function of time), which may enhance security and privacy. Additionally, this trait-based authentication may reflect or may be relative to the baseline capabilities of the individual at a given time, and therefore may be used by an individual that has a handicap (such as a physical or a cognitive disability). Thus, while the authentication techniques may or may not be used with other authentication techniques, the described approach may provide accurate authentication without may of the limitations associated with other authentication techniques, and may improve the user experience.

We now describe some embodiments of the recommendation techniques and the authentication techniques. In the discussion that follows, Long Term Evolution or LTE (from the 3rd Generation Partnership Project of Sophia Antipolis, Valbonne, France) is used as an illustration of a data communication protocol that is used one or more radio nodes in a cellular-telephone network. The one or more radio nodes may facilitate communication between a computer (or a server) and an electronic device associated with a user (such as an individual). Consequently, the one or more radio nodes may include an Evolved Node B (eNodeB) or eNBs. In some embodiments, the communication protocol used by the one or more radio nodes may include: a third generation or 3G communication protocol, a fourth generation or 4G communication protocol, e.g., LTE, LTE Advanced or LTE-A, a fifth generation or 5G communication protocol, or other present or future developed advanced cellular communication protocol. Therefore, in other embodiments the one or more radio nodes may include: a Universal Mobile Telecommunications System (UMTS) NodeB and radio network controller (RNC), or a New Radio (NR) gNB or gNodeB (which communicate with a network with a cellular-telephone communication protocol that is other than LTE).

Alternatively or additionally, an Institute of Electrical and Electronics Engineers (IEEE) 802.11 standard (which is sometimes referred to as ‘Wi-Fi,’ from the Wi-Fi Alliance of Austin, Tex.) is used as an illustration of a communication protocol that is used by an access point in a wireless local area network (WLAN) to facilitate the communication between the computer (or the server) and the electronic device. For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. However, a wide variety of communication techniques or protocols may be readily used in various embodiments. For example, an electronic device and a radio node or an access point may communicate frames or packets in accordance with a wireless communication protocol, such as: Bluetooth (from the Bluetooth Special Interest Group of Kirkland, Washington), and/or another type of wireless interface.

Moreover, a radio node or the access point may communicate with other access points, radio nodes and/or computers in a network using a wired communication protocol, such as an IEEE 802.3 standard (which is sometimes referred to as ‘Ethernet’) and/or another type of wired interface. In the discussion that follows, Ethernet is used as an illustrative example.

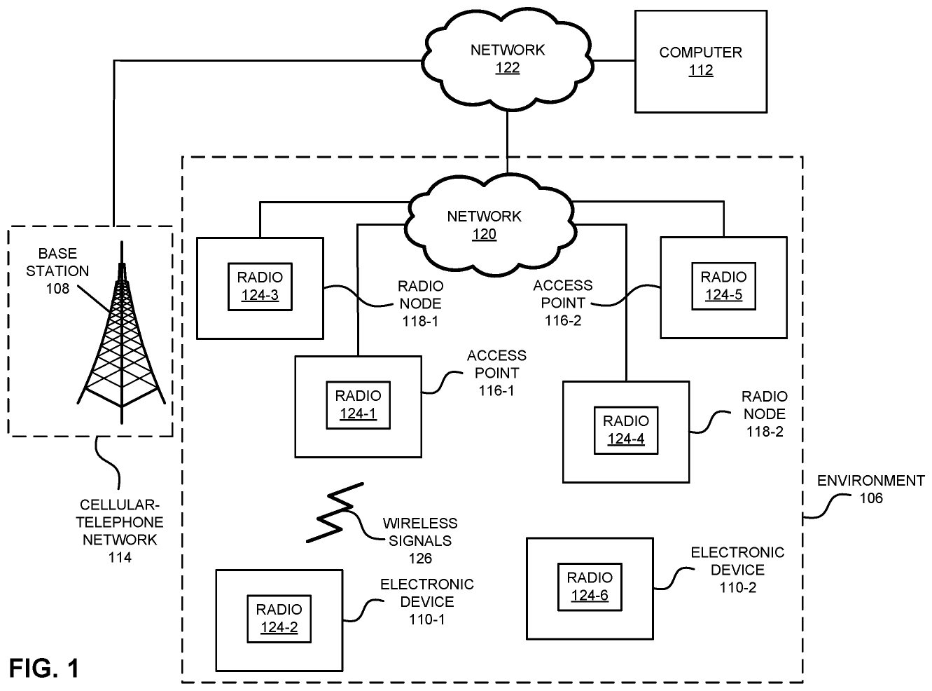

FIG. 1 presents a block diagram illustrating an example of communication in an environment 106 with one or more electronic devices 110 (such as cellular telephones, portable electronic devices, stations or clients, another type of electronic device, etc.) via a cellular-telephone network 114 (which may include a base station 108), one or more access points 116 (which may communicate using Wi-Fi) in a WLAN and/or one or more radio nodes 118 (which may communicate using LTE) in a small-scale network (such as a small cell). In the discussion that follows, an access point, a radio node or a base station are sometimes referred to generically as a ‘communication device.’ Moreover, as noted previously, one or more base stations (such as base station 108), access points 116, and/or radio nodes 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other and/or computer 112 (which may be a cloud-based computer or server) using a wired communication protocol (such as Ethernet) via network 120 and/or 122. Note that networks 120 and 122 may be the same or different networks. For example, networks 120 and/or 122 may an LAN, an intra-net or the Internet.

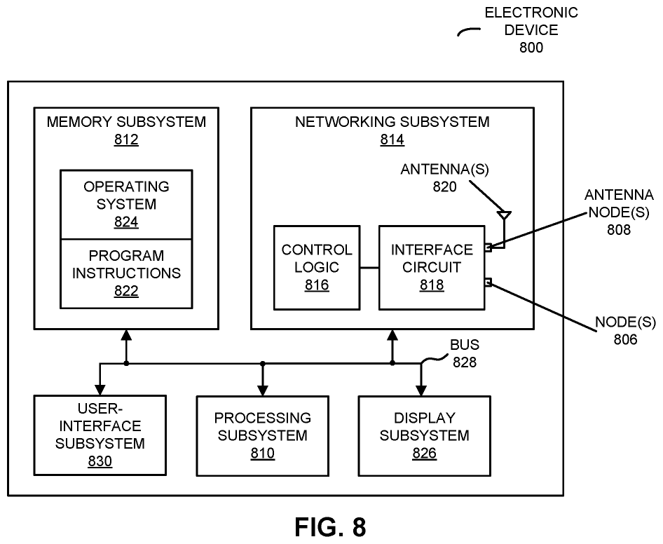

As described further below with reference to FIG. 8, electronic devices 110, computer 112, access points 116, and radio nodes 118 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, it can be time-consuming, intrusive to perform a skills assessment. Moreover, the results of the skills assessment, and thus any subsequent actions (such as selectively providing a recommendation) may have reduced accuracy because of biases, e.g., of an individual that conducts a self-assessment.

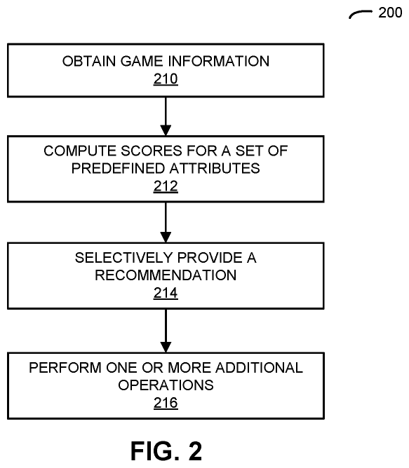

As described further below with reference to FIGS. 2-4, in order to address these problems, computer 112 may selectively provide a recommendation. Notably, computer 112 may obtain game information associated with one or more video games played by an individual, where the game information specifies decisions and behaviors in the one or more video games while the individual played the one or more video games. Note that the decisions and the behaviors may include or correspond to at least one of actions taken or potential actions not taken during the one or more video games.

The game information may be predetermined and the obtaining may include computer 112 accessing the game information in local and/or remotely located memory (which may include game information previously collected by a developer or provider of a video game and/or a platform or environment that hosts the video game). Alternatively or additionally, the obtaining may include measuring the game information while the individual plays the one or more video games (e.g., in real time). These measurements may include interaction with an electronic device (such as electronic device 110-1 or, in other embodiments, another computer that provides the video game to electronic device 110-1) associated with or used by the individual when the individual plays the one or more video games. Notably, computer 112 may request and then may receive measurements from electronic device 110-1. For example, the measurements may include obtaining monitoring data of the individual while the individual played the one or more video games. This monitoring data may specify or may include at least one of: physiological data of the individual, a gaze direction of the individual, eye motion of the individual, a posture of the individual, fidgeting of the individual, body language of the individual, user-interface actions of the individual, a type of micro-expression of the individual and/or a type of facial expression of the individual. In some embodiments, the measurements (such as of the monitoring data) may be performed by one or more sensors in or associated with (and in communication with) electronic device 110-1, such as: a user-interface device or a video-game controller (e.g., a joy stick, a keyboard, a mouse, a track pad, a touch-sensitive display, a haptic interface, a non-contact interface, e.g., a time-of-flight-based interface, a voice interface, etc.), a vital-sign sensor (e.g., a pulse or respiration monitor, a skin-temperature monitor, a perspiration monitor, a skin-flushing sensor, a blood-pressure monitor, etc.), one or more image sensors (e.g., a CMOS or a CCD sensor, a camera, a stereoscopic camera, a three-dimension camera, etc.), one or more electroencephalogram electrodes sensors, one or more electromyographic electrodes or sensors, one or more muscle sensors, an accelerometer, a vibration or motion sensor, etc. The one or more sensors may perform contact and/or non-contact (or non-invasive) measurements. Moreover, electronic device 110-1 and/or computer 112 may analyze the measurements to compute the game information.

Note that the game information may correspond to or may be a function of one or more types of events during a given video game in the video games. For example, the one or more types of events may include: a time to perform a task in a given video game when given a directive (or an instruction, such as a time to find a hidden object); a reaction time to a change in a state of a given video game (such as a time needed to shoot an opponent that suddenly appears); a mistake by the individual; and/or an instance of cheating by the individual based at least in part on instructions or a briefing associated with the given video game. Moreover, the game information may include: titles of the one or more video games, types of the one or more video games (such as solo or multi-player video games), genres of the one or more video game (prosocial video games, role-playing video games, battle royale video games, fighting video games, etc.), avatar choice, weapon or spell use, a number of times a given video game was played, assists to at least another player by the individual during the one or more video games (which may include or account for whether an assist was accidental or intentional), deaths of the individual in the one or more video games, whether the individual played the video game again after being killed, kills by the individual in the one or more video games, wins by the individual in the one or more video games, and/or losses by the individual in the one or more video games. Thus, the game information may include one or more performance metrics (such as statistics) for the individual that summaries their performance when playing the video game.

Then, computer 112 may compute, for the individual, scores for a set of predefined attributes associated with occupations based at least in part on the decisions and/or the behaviors. For example, computer 112 may map temporal patterns of the decisions and/or behaviors to the set of predefined attributes to compute the scores. In some embodiments, computer 112 may calculate a vector projection (or dot product) of the decisions and/or behaviors with the set of predefined attributes to compute the scores, and the scores may correspond to the resulting direction cosines. Alternatively or additionally, computer 112 may determine the scores as weights in a linear and/or nonlinear fit of one or more of the predefined attributes to a linear superposition of the decisions and/or behaviors. In some embodiments, the decisions and/or behaviors may be used as inputs to one or more pretrained machine-learning models or one or more pretrained neural networks, which output(s) the scores.

Note that the set of predefined attributes may include categories of occupational information. These categories of occupational information may include one or more of: worker characteristics, worker requirements, worker experience, worker skills, and/or occupational requirements associated with different occupations. For example, the categories of occupational information may include O*NET data from the U.S. Department of Labor. In some embodiments, the set of predefined attributes may be different from personality types or a personality assessment.

Next, computer 112 may selectively provide the recommendation based at least in part on the computed scores. For example, computer 112 may provide the recommendation to electronic device 110-1. Note that the recommendation may be associated with: an academic area of study for the individual (such as a major, e.g., biology or physics), an employment opportunity for the individual (such as a current job posting), and/or an occupation for the individual (such as a profession, e.g., a type of physician, a type of lawyer, accounting, law enforcement, etc.).

While the preceding discussion illustrated the recommendation techniques using game information of the individual, in other embodiments the selective providing of the recommendation may be based at least in part on game information associated with one or more other individuals. Notably, computer 112 may aggregate game information of multiple individuals for the one or more video games (e.g., from local and/or remotely located memory, which may include game information previously collected by a developer or provider of the video game and/or a platform or environment that hosts the video game), and the computing of the scores may include comparing the game information of the individual to the aggregated game information of the multiple individuals or one or more moments of at least a distribution corresponding to the aggregated game information of the multiple individuals. For example, the aggregated game information of the multiple individuals (such as up to several hundred individuals) may provide or specify a baseline (with associated means and standard deviations for the set of predefined attributes), and computing a given score may involve assessing the statistical significance (e.g., the p-value) of the given score relative to a mean score and a standard deviation about this mean score for the multiple individuals. In some embodiments, the quality or accuracy of the given score may be determined using a confidence interval. Alternatively or addition, in some embodiments, the quality or accuracy of the scores (such as confidence intervals) may be determined using one or more pretrained machine-learning models or one or more one or more pretrained neural networks, which output(s) quality scores or metrics for the computed scores.

Furthermore, in some embodiments, the recommendation techniques may involve an iterative procedure, such as feedback being provided from computer 112 to electronic device 110-1 and, in response, additional game information and/or measurements being acquired and provided to computer 112. For example, computer 112 may: selectively provide, to electronic device 110-1, a request (e.g., based at least in part on the one or more quality scores or metrics for one or more of the scores) that the individual repeat playing of one or more of the video games based at least in part on confidence intervals (or the quality scores or metrics) of one or more of the scores of one or more of the predefined attributes in the set of predefined attributes; obtain additional game information associated with the repeated playing of the one or more video games (e.g., from electronic device 110-1), where the additional game information specifies additional decisions and additional behaviors in the repeated playing of the one or more video games while the individual repeated playing of the one or more video games; and computing, for the individual, revised scores for the one or more predefined attributes based at least in part on the additional decisions and/or the additional behaviors. Note that the selective providing of the recommendation may be further based at least in part on the computed revised scores. As noted previously, the confidence intervals (or quality scores or metrics) and, thus, the request, may be based at least in part on the output(s) of one or more pretrained machine-learning model or one or more pretrained neural networks.

Additionally, the recommendation techniques may be used to make other types of recommendations, such as: a romantic partner (e.g., in a dating application), pairing of players in a video game (e.g., an opponent or a partner), a competitive bracket or group for a video game, skills or abilities where further training may be needed, and/or another type of human activity or behavior than those discussed previously.

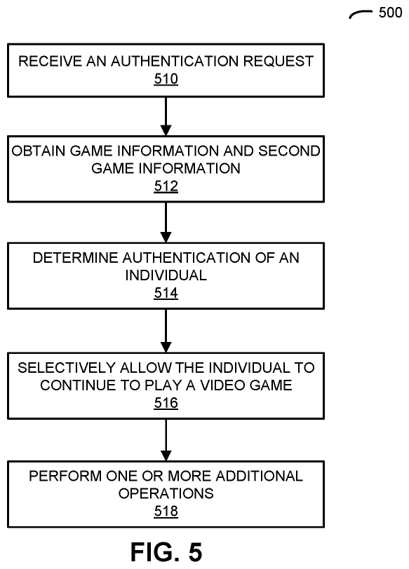

As discussed previously, there are often problems associated with existing authentication techniques. Moreover, as described further below with reference to FIGS. 5-7, in order to address these problems, computer 112 may receive an authentication request associated with an individual playing a video game. For example, the authentication request may be received from electronic device 110-1. Alternatively, the authentication request may be received from another computer or computer system (not shown) that, at least in part, provides the video game to electronic device 110-1.

In response to the authentication request, computer 112 may obtain game information associated with current play of the video game by the individual and second game information associated with one or more prior instances of the individual playing the video game. For example, the game information and the second game information may specify decisions and behaviors of the individual in the video game while the individual is playing or played the video game. Alternatively or additionally, the game information and the second game information may specify interactions in the video game with another player while the individual and the other player play or played the video game.

The game information and/or the second game information may be predetermined and the obtaining may include computer 112 accessing the game information in local and/or remotely located memory (which may include game information previously collected by a developer or provider of a video game and/or a platform or environment that hosts the video game). Alternatively or additionally, the obtaining may include measuring the game information while the individual plays the video game. These measurements may include interaction with an electronic device (such as electronic device 110-1 or, in other embodiments, another computer that provides the video game to electronic device 110-1) associated with or used by the individual when the individual plays the video game. Notably, computer 112 may request and then may receive measurements from electronic device 110-1. For example, the measurements may include obtaining monitoring data of the individual while the individual is playing or played the video game. This monitoring data may specify or may include at least one of: physiological data of the individual, a gaze direction of the individual, eye motion of the individual, a posture of the individual, fidgeting of the individual, body language of the individual, user-interface actions of the individual, a type of micro-expression of the individual and/or a type of facial expression of the individual. In some embodiments, the measurements may be performed by one or more sensors in or associated with (and in communication with) electronic device 110-1. Moreover, electronic device 110-1 and/or computer 112 may analyze the measurements to compute the game information.

Then, computer 112 may determine the authentication of the individual based at least in part on the game information and the second game information. Next, computer 112 may selectively allow the individual to continue to play the video game based at least in part on the authentication. For example, in embodiments where computer 112, at least in part, provides the video game to electronic device 110-1, computer 112 may gate further playing of the video game by the individual based at least in part on the determined authentication. Alternatively, computer 112 may provide information that specifies the determined authentication to electronic device 110-1, which may gate further playing of the video game by the individual based at least in part on the determined authentication. In some embodiments, computer 112 may provide information that specifies the determined authentication to another computer or computer system (not shown) that, at least in part, provides the video game to electronic device 110-1, and which may gate further playing of the video game by the individual based at least in part on the determined authentication.

Note that the determining of the authentication may be based at least in part on a location of electronic device 110-1 associated with the individual. For example, the location may include a geographic location, such as location of a residence of the individual, e.g., a residential address, a country of residence, etc. or a historical geographic location where the individual has been located when the individual previously played the video game. Alternatively or additionally, the location may include a location of electronic device 110-1 in a network. Notably, the authentication request may include an identifier of electronic device 110-1 associated with the individual and the determining of the authentication may be based at least in part on the identifier. For example, the identifier may include an IP address. In some embodiments, the identifier may include a MAC address.

Moreover, the authentication request may include an encrypted value associated with the individual and the determining the authentication is based at least in part on the encrypted value. This encrypted value may be based at least in part on a predefined alphanumeric value. For example, the predefined alphanumeric value may include a random number or a pseudorandom number. In some embodiments, the predefined alphanumeric value may be encrypted using an encryption technique and a symmetric or an asymmetric encryption key of the individual. If computer 112 is able to decrypt the encrypted value to recover the predefined alphanumeric value, computer 112 may authenticate the individual. Note that, in these embodiments, the predefined alphanumeric value and at least a portion of the encryption may be shared in advance between electronic device 110-1 and computer 112, so that they do not need to be included in the authentication request.

Alternatively or additionally, the authentication request may include an alphanumeric value and the encrypted value may correspond to the alphanumeric value, and computer 112 may: calculate a second encrypted value based at least in part on the alphanumerical value, an encryption technique and a predefined encryption key associated with the individual (such as a symmetric or an asymmetric key); and comparing the encrypted value and the second encrypted value, where the determining of the authentication is based at least in part on the comparison. For example, the individual may be authenticated when the encrypted value and the second encrypted value are the same. Note that, in these embodiments, at least a portion of the encryption may be shared in advance between electronic device 110-1 and computer 112, so that it does not need to be included in the authentication request.

In some embodiments, a cryptographic calculation may be used instead of encryption. Notably, electronic device 110-1 may compute a result of a predefined cryptographic calculation using the alphanumeric value, computer 112 may compute a second result of the predefined cryptographic calculation using the alphanumeric value, and the individual may be authenticated when the result and the second result are the same. Note that, in these embodiments, aspects of the predefined cryptographic calculation (such as a seed value) may be shared in advance between electronic device 110-1 and computer 112, so that they do not need to be included in the authentication request.

Moreover, the authentication request may include a biometric identifier of the individual and the determining the authentication may be based at least in part on the biometric identifier. More generally, the authentication request may include authentication information associated with one or more authentication techniques (such as a password, a token, a certificate, etc.), and the authentication may be based at least in part on the authentication information. Thus, the authentication techniques may be used separately from or in conjunction with one or more other authentication techniques.

Furthermore, the determining of the authentication may be based at least in part on an output of a pretrained machine-learning model or a pretrained neural network. For example, the game information, the second game information and/or additional information included in the request may be inputs to the pretrained machine-learning model or the pretrained neural network, and the authentication (or an authentication value or result) may be output from the pretrained machine-learning model or the pretrained neural network.

In some embodiments, computer 112 may link an identity (such as an identifier) of the authenticated individual to a virtual object or an attribute obtained in an environment of the video game. This identity may be selectively transferrable to a third party (such as a company or an organization) or another individual (such as another player of at least the video game). Note that the attribute may include: a skill, or an achievement. Moreover, the identity may be unique and immutable. Thus, once the individual is authenticated, the virtual object or attribute (which may be won or purchased) may be associated with the individual, and the individual may be able to selectively (e.g., at their discretion) transferred to the third party of the other individual.

Moreover, computer 112 may link a second identity (such as a second identifier) of the authenticated individual to the game information and/or the second game information. This second identity may be the same as or different from the identity. In some embodiments, the second identity may be transferrable to a third party or another individual. Note that the second identity may be unique and immutable.

While the preceding discussion illustrated the authentication techniques using game information for the individual that is associated with a video game, in other embodiments the authentication may be determined based at least in part on game information for the individual that is associated with multiple video games. For example, the game information may be associated with current play of the video game by the individual and second game information may be associated with one or more prior instances of the individual playing the video game and/or one or more additional video games. Note that, in the recommendation techniques and/or the authentication techniques, the multiple video games may have a common or a similar content (such as a common genre) or contexts (such as information that specifies knowledge, skills, abilities and other characteristics associated with a given video game), which may facilitate their use in aggregate to compute the scores of the individual and/or to determine the authentication of the individual.

Furthermore, while the preceding discussion illustrated the recommendation techniques and the authentication techniques with computer 112 remotely located from electronic device 110-1, in embodiments at least some of the described operations are performed locally and/or remotely. For example, computer 112 may be located locally, such as in environment 106. Moreover, in some embodiments at least some of the operations may be performed by electronic device 110-1. Notably, instead of computing the scores and/or the authentication, computer 112 may provide instructions that are used by electronic device 110-1 to perform these operations. In some embodiments, software or a standalone application that performs the recommendation techniques and/or the authentication techniques is installed on and executed in an environment of electronic device 110-1, such as a Web browser or an operating system. Thus, in some embodiments, all the operations may be performed by electronic device 110-1. Alternatively, in some embodiments, the recommendation techniques and/or the authentication techniques are implemented using a client-server architecture, such as that provided using electronic device 110-1 and computer 112.

We now describe embodiments of the method in the recommendation techniques. FIG. 2 presents a flow diagram illustrating an example of a method 200 for selectively providing a recommendation, which may be performed by a computer (such as computer 112 in FIG. 1). During operation, the computer may obtain game information (operation 210) associated with one or more video games played by an individual, where the game information specifies decisions and behaviors in the one or more video games while the individual played the one or more video games. For example, the decisions and the behaviors may include or correspond to at least one of actions taken or potential actions not taken during the one or more video games.

Note that the game information may correspond to one or more types of events during a given video game in the video games. For example, the one or more types of events may include: a time to perform a task in a given video game when given a directive (or an instruction); a reaction time to a change in a state of a given video game; a mistake by the individual; and/or an instance of cheating by the individual based at least in part on instructions or a briefing associated with the given video game. Moreover, the game information may include: titles of the one or more video games, types of the one or more video games (such as solo or multi-player video games), genres of the one or more video game (prosocial video games, role-playing video games, battle royale video games, fighting video games, etc.), avatar choice, weapon or spell use, a number of times a given video game was played, assists to at least another player by the individual during the one or more video games (which may include or account for whether an assist was accidental or intentional), deaths of the individual in the one or more video games, whether the individual played the video game again after being killed, kills by the individual in the one or more video games, wins by the individual in the one or more video games, and/or losses by the individual in the one or more video games.

Then, the computer may compute, for the individual, scores for a set of predefined attributes (operation 212) associated with occupations based at least in part on the decisions and/or the behaviors. Note that the computing of the scores may be based at least in part on temporal patterns of the decisions and the behaviors.

In some embodiments, the set of predefined attributes may include categories of occupational information. These categories of occupational information may include one or more of: worker characteristics, worker requirements, worker experience, worker skills, and/or occupational requirements associated with different occupations. For example, the categories of occupational information may include O*NET data. Note that the set of predefined attributes may be different from personality types or a personality assessment.

Next, the computer may selectively provide the recommendation (operation 214) based at least in part on the computed scores, where the recommendation is associated with: an academic area of study for the individual, an employment opportunity for the individual, and/or an occupation for the individual.

In some embodiments, the computer may optionally perform one or more additional operations (operation 216). For example, the computer may obtain monitoring data of the individual while the individual played the one or more video games. This monitoring data may specify or may include at least one of: physiological data of the individual, a gaze direction of the individual, eye motion of the individual, a posture of the individual, fidgeting of the individual, body language of the individual, user-interface actions of the individual, a type of micro-expression of the individual and/or a type of facial expression of the individual.

Additionally, the game information may be predetermined and the obtaining may include accessing the game information in memory. Alternatively or additionally, the obtaining may include measuring the game information while the individual plays the one or more video games.

In some embodiments, the computer may aggregate game information of multiple individuals for the one or more video games, and the computing of the scores may include comparing the game information of the individual to the aggregated game information of the multiple individuals or one or more moments of at least a distribution corresponding to the aggregated game information of the multiple individuals.

Moreover, the computer may: selectively request that the individual repeat playing of one or more of the video games based at least in part on confidence intervals of one or more of the scores of one or more of the predefined attributes in the set of predefined attributes; obtain additional game information associated with the repeated playing of the one or more video games, where the additional game information specifies additional decisions and additional behaviors in the repeated playing of the one or more video games while the individual repeated playing of the one or more video games; and compute, for the individual, revised scores for the one or more predefined attributes based at least in part on the additional decisions and/or the additional behaviors. The selective providing of the recommendation may be further based at least in part on the computed revised scores. Note that the request may be based at least in part on an output of a pretrained machine-learning model or a pretrained neural network.

In some embodiments of method 200, there may be additional or fewer operations. Furthermore, the order of the operations may be changed, and/or two or more operations may be combined into a single operation.

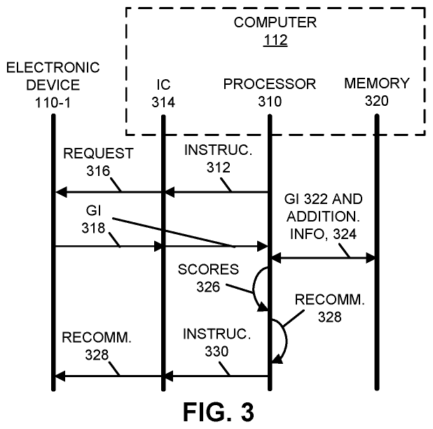

Embodiments of the recommendation techniques are further illustrated in FIG. 3, which presents a drawing illustrating an example of communication among computer 112 and electronic device 110-1. In FIG. 3, processor 310 in computer 112 may be executing an application (or program instructions). During this application, processor 310 may instruct 312 interface circuit (IC) 314 in computer 112 to request 316 game information (GI) 318 from electronic device 110-1. Note that an individual may be playing one or more video games on or using electronic device 110-1.

After receiving request 316, electronic device 110-1 may provide game information 318 to computer 112. This may involve electronic device 110-1 performing one or more measurements while the individual plays the one or more video games on or using electronic device 110-1.

Moreover, after receiving game information 318, interface circuit 314 may provide game information 318 to processor 310. Furthermore, processor 310 may access, in memory 320 in or associated with computer 112, predetermined game information 322 or additional information 324 associated with the one or more video games. In some embodiments, processor 310 may access, in memory 320, information associated with one or more pretrained machine-learning models or one or more pretrained neural networks.

Then, processor 310 may compute, for the individual, scores 326 for a set of predefined attributes associated with occupations based at least in part on game information 318, game information 322 and/or additional information 324.

Next, processor 310 may determine, for the individual, a recommendation 328 based at least in part on the computed scores 326. For example, processor 310 may calculate a mapping from the computed scores 326 to recommendation 328 in a group of recommendations. Notably, values of scores 326 and/or a pattern of scores 326 may correspond to recommendation 328. In some embodiments, particular predefined attributes (such as 1-10 attributes) may correspond to or may be associated with recommendation 328. Thus, a summation of the computed scores for the particular predefined attributes may be summed and compared to a predefined value and, when the sum exceeds the predefined value, processor 310 may select recommendation 328. Alternatively or additionally, processor 310 may compute a vector product of scores 326 with a group of recommendations, and may select recommendation 328 based at least in part on resulting direction cosine(s). More generally, processor 310 may use scores 326 as inputs to one or more pretrained machine-learning models or one or more pretrained neural networks, which may provide output(s) that specify recommendation 328. Note that, using one or more of the aforementioned computational techniques, processor 310 may compute values for a group of recommendations, which are then ranked to select recommendation 328.

Furthermore, processor 310 may selectively instruct 330 interface circuit 314 to provide recommendation 328, e.g., to electronic device 110-1. Processor 310 may provide this instruction to interface circuit 314 (and, thus, computer 112 may selectively provide recommendation 328) based at least in part on computed scores 326. For example, recommendation 328 may be provided when one or more confidence intervals associated with computed scores 326 exceeds a predefined value, such as 80, 90 or 95%. Note that recommendation 328 may be associated with: an academic area of study for the individual, an employment opportunity for the individual, and/or an occupation for the individual. Thus, computer 112 may recommend a major or a minor area study at an academic institution or school, a job opportunity, and/or an occupation or a profession to the individual.

While FIG. 3 illustrates communication between components using unidirectional or bidirectional communication with lines having single arrows or double arrows, in general the communication in a given operation in this figure may involve unidirectional or bidirectional communication.

We now further describe embodiments of the recommendation techniques. Traditional approaches for attracting and retaining prospective employees are proving less effective for recent generations (such as Gen Z). In addition, video games are increasingly popular with teenagers and young adults. In the disclosed recommendation techniques, video-gameplay data (such as decisions and behaviors) for an individual is mapped or linked to historically validated O*NET-based competencies. The resulting competency-based video-game profile (which is sometimes referred to as a ‘personal gaming profile’) may describe a level of proficiency of an individual on a set of competencies, abilities or skills that have been mapped to O*NET predefined attributes or descriptors. This gaming profile may be used to provide recommendations to the individual (such as recommendations associated with educational, reemployment or recruitment, retention, etc.), and/or may be used to provide recommendations to a perspective employer, thesis adviser, academic department or institution, etc. Moreover, the individual may use this gaming profile to provide insights about opportunities for growth and to explore educational opportunities, careers or career paths, and/or jobs. For example, an individual may share their gaming profile by appending it (or a link to the gaming profile) to their resume, job applications, career-placement or corporate-recruiting portals, social-media websites (such as a social-media website for professionals), etc. The recommendation techniques may offer video-game developers improved visibility and engagement with players, as well as potential revenue opportunities to monetize video-gameplay data. In addition, the recommendation techniques may help an institution (such as a university, a college or a school) connect with gamers or players by increasing contact and engagement by providing a value-added community. This capability may: enhance student recruitment and retention; help to build an educational curriculum; bridge a gap between enrollment recruiting and professional development via a social network after graduation.

Consequently, the recommendation techniques may provide a pervasive, dynamic (or self-updating) skills-assessment tool that can increase, e.g., student engagement and retention at colleges and universities. Furthermore, the recommendation techniques may enable organizations to effectively recruit and retain digitally-savvy, video-game playing workers and, in turn, give these possibly high-potential workers/job seekers new, innovative, and engaging tools to explore careers, understand their capabilities (e.g., skills, competencies, etc.), and to land good-fitting jobs.

In the recommendation techniques, game information may be collected for individuals playing prosocial video games, massively multi-player online video games and/or role-playing video games. Prosocial video games may require gamers to help other players within the video game, or to act as part of a team. This emphasis on social interaction may require a more expansive set of skills and behaviors to play and succeed in the video game. Moreover, massively multi-player online video games may require gamers to act on their own, and with others, to accomplish goals. These video games may require a more expansive set of skills and behaviors for successful play. Furthermore, role-playing video games may involve leveling up, evolving personal attributes and completing quests.

Furthermore, many kinds of data may be collected during video gaming. For example, the game information may include: high scores, being first, winning, prestige, achievements, booster, etc. (which are sometimes referred to as a ‘gammerscore’ or a ‘completionist’); and/or attributes (such as features, characteristics, and variables) related to gameplay, the gamer (in an individual level or personal to a gamer or individual), gamers (in an aggregate level), and/or teams (such as in a social network). Gameplay attributes may include: game statistics, scores, metrics across a video game, hero, ability, ammo, damage, fire rate, cool down/reload, cast time, cast duration, range, spawn location, a number of times respawned, game completion time, types of boosters used, kills, deaths, ultimate abilities used (which are sometimes referred to as ‘ULT’), first kills/first deaths of a fight, key strokes, reaction time, decision trees, and/or ULT efficiency. Additionally, gamer attributes may include: rank, trend, a number of heroes uses, types of heroes used, a team, stability of a team, how frequently a player changes video games, is their gameplay stable across video games, does a player change their role on a team, how often does a player change their role on a team, an opponent, a result, an individual game console, dates video games were played, an amount of time spent playing a video game, a quitting point in a video game, how much money is spent in a video game, and/or the other players who play with a gamer. Demographic attributes (or an individual or in aggregate) may include: sex/gender, age, a team, platform used (computer, console, mobile, etc.), and/or an Internet provider. In some embodiments, gamer social network attributes (or players or a team) may reflect social networking aspects of team-based gaming across different video games. The gamer social network attributes may be described or represented by a social graph.

As discussed previously, in the recommendation techniques decisions and behaviors during video game play may be used a tool to assess competencies or skills, such as: leadership, problem solving, innovation, critical thinking, cognitive ability or thinking, decision-making, creativity or originality, communication, persistence, and/or flexibility. For example, persistence is a component of many activities and jobs. Some gameplay statistics may measure persistence. Notably, how many times a gamer respawns, or how many wins a gamer has may indicate persistence. Similarly, whether a player repeats playing of a video game after being killed may indicate persistence. Moreover, a time-to-task measurement, where a player is given a directive and then chooses a correct path in a video game, may reflect problem-solving capability. This game information may also be used to guide player pairing. Furthermore, relationships between other game information and competencies or skills may include: a time to respond (e.g., when an enemy appears and a player responds with a mouse movement/click) may indicate a reaction time; playing a solo versus a multi-player game may indicate autonomy; and/or avoiding traps in a video game (e.g., did an individual get trapped?, how long were they stuck?, did they use experience and team mates to avoid a trap?, etc.) may reflect critical thinking.

In some embodiments, the game information may include: omissions/commissions (such as mistaking a friend for a foe); and/or cheating. Notably, cheating may be determined based at least in part on briefing in a video game. For example, dis a player run off a map multiple times, such as five times. Alternatively or additionally, did a player intentionally cheat to loose (such as in action in response to an enemy and then claiming that the user interface did not work), or cheat to win by collusion. Note that the game information may include quantitative and/or qualitative measurements. Table 1 provides examples of game information (such as gaming actions and associated variables) and potential competencies.

TABLE 1

| Gaming | | Potential |
|---|---|---|
| Action | Variable(s) | Competency |
| Player | • Time to get | Problem |
| proceeds | to checkpoint | Solving |
| or is stuck | • Choice of checkpoint | |
| Avoiding | • Number of traps got into | Critical |
| traps | • Amount of time to | Thinking |
| | get out of trap | |
| Help another | • Whether player helps | Teamwork |
| player get by | another player | |
| obstacle | • How many others helped | |
| Overcome | • Time to recognize challenge | Originality |
| challenge | • Tactical choice(s) | |
| | • Strategies used | |
| Characters | • Which abilities are | Leadership |
| capitalize on | used/unlocked | |
| and organize | • How teams are configured | |
| unique | • Which tools/weapons | |
| abilities | are used | |

Based at least in part on the unique patterns or history of decisions or behaviors by an individual over time (such as actions taken or not taken in different circumstances in a video game), statistical associations with predefined attributes (such as O*NET descriptors) may be determined. Note that O*NET descriptors (e.g., which describe occupations in terms of knowledge, skills, work activities, abilities, interests, work context, work styles in terms of how work is performed or activities or tasks, and work values) include psychological constructs that describe occupations and may be related to job performance. By mapping video-game competency-based attributes to O*NET descriptors, the wealth of occupational information that is accessible in O*NET can be leveraged by individuals, organizations and companies. In some embodiments, mapping from decisions and behaviors to O*NET predefined attributes may involve factor analysis, which may allow two or more features to be combined, thereby reducing the size or dimensionality of the feature space in the mapping or the analysis. Table 2 provides some examples of O*NET predefined attributes that may be related to video-game decisions and behaviors.

TABLE 2

| O*NET Data | |
|---|---|
| Descriptor | Specific Element |
| Critical Thinking | Using logic and reasoning to identify the |
| | strengths and weaknesses of alternative |
| | solutions, conclusions or approaches to |
| | problems. |
| Mathematics | Using mathematics to solve problems |
| Complex Problem | Identifying complex problems and |
| Solving | reviewing related information to develop |
| | and evaluate options and implement |
| | solutions. |
| Judgment and | Considering the relative costs and benefits |
| Decision Making | of potential actions to choose the most |
| | appropriate one. |
| Systems | Identifying measures or indicators of system |
| Evaluation | performance and the actions needed to |
| | improve or correct performance, relative to |
| | the goals of the system. |
| Coordination | Adjusting actions in relation to others' |
| | actions. |
| Service | Actively looking for ways to help people. |
| Orientation | |
| Abilities Inductive | The ability to combine pieces of |
| Reasoning | information to form general rules or |
| | conclusions (includes finding a relationship |
| | among seemingly unrelated events). |
| Memorization | The ability to remember information such as |
| | words, numbers, pictures, and procedures. |
| Selective | The ability to concentrate on a task over a |
| Attention | period of time without being distracted. |
| Speed of Closure | The ability to quickly make sense of, |
| | combine, and organize information into |
| | meaningful patterns. |
| Work Activities | Observing, receiving, and otherwise |
| Getting | obtaining information from all relevant |
| Information | sources. |
| Developing | Establishing long-range objectives and |
| Objectives | specifying the strategies and actions to |
| and Strategies | achieve them. |
| Making Decisions | Analyzing information and evaluating |
| and | results to choose the best solution and solve |
| Solving Problems | problems. |

In some embodiments, the personal gaming profile of an individual may be secured and monitored, e.g., using a blockchain-based permission system. This system may track access to the personal gaming profile and may store access information in a secure ledger or a data structure.

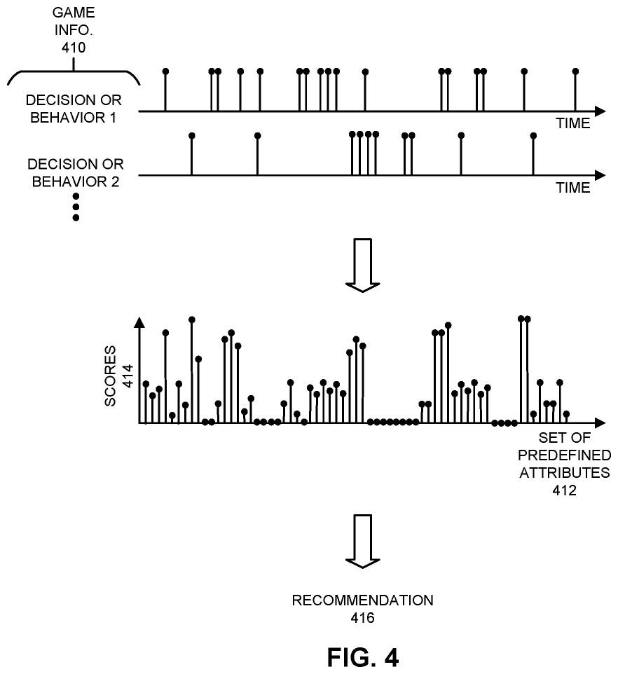

FIG. 4 presents a drawing illustrating an example of selectively providing a recommendation to an individual in accordance with an embodiment of the present disclosure. Notably, a computer may obtain game information 410 associated with one or more video games played by an individual. This game information may specify decisions and behaviors in the one or more video games while the individual played the one or more video games. For example, game information 410 may include temporal patterns of decisions and behaviors of the individual while playing the one or more video games.

Then, the computer may compute, for the individual, scores 414 for a set of predefined attributes 412 associated with occupations based at least in part on the decisions and/or the behaviors.

Next, the computer may select or generate a recommendation 416 based at least in part on the computed scores 414, and the computer may selectively provide recommendation 416. Note that recommendation 416 may be associated with: an academic area of study for the individual, an employment opportunity for the individual, and/or an occupation for the individual.

We now describe embodiments of the method in the authentication techniques. FIG. 5 presents a flow diagram illustrating an example of a method 500 for selectively providing a recommendation, which may be performed by a computer (such as computer 112 in FIG. 1). During operation, the computer may receive an authentication request (operation 510) associated with an individual playing a video game.

In response to the authentication request, the computer may obtain game information (operation 512) associated with current play of the video game by the individual and second game information (operation 512) associated with one or more prior instances of the individual playing the video game. Note that the game information and the second game information may specify decisions and behaviors of the individual in the video game while the individual is playing or played the video game. Alternatively or additionally, the game information and the second game information may specify interactions in the video game with another player while the individual and the other player play or played the video game. Moreover, the game information and the second game information may include monitoring data of the individual while the individual is playing or played the video game. This monitoring data may specify or include at least one of: physiological data of the individual, a gaze direction of the individual, eye motion of the individual, a posture of the individual, fidgeting of the individual, body language of the individual, user-interface actions of the individual, a type of micro-expression of the individual and/or a type of facial expression of the individual.

Then, the computer may determine the authentication of the individual (operation 514) based at least in part on the game information and the second game information. Next, the computer may selectively allow the individual to continue to play the video game (operation 516) based at least in part on the authentication. For example, the computer may selectively allow the individual to continue to play the video game when they are authenticated.

In some embodiments, the computer may optionally perform one or more additional operations (operation 518). For example, the determining of the authentication may be based at least in part on a location of an electronic device associated with the individual.

Moreover, the authentication request may include an identifier of an electronic device associated with the individual and the determining of the authentication may be based at least in part on the identifier. For example, the identifier may include a MAC address or an IP address.

Furthermore, the authentication request may include an encrypted value associated with the individual and the determining the authentication may be based at least in part on the encrypted value. This encrypted value may be based at least in part on a predefined alphanumeric value. For example, the predefined alphanumeric value may include a random number or a pseudorandom number. Alternatively or additionally, the authentication request may include an alphanumeric value and the encrypted value may correspond to the alphanumeric value, and the computer may: calculate a second encrypted value based at least in part on the alphanumerical value and a predefined encryption key associated with the individual; and compare the encrypted value and the second encrypted value, where the determining of the authentication is based at least in part on the comparison.

Additionally, the authentication request may include a biometric identifier of the individual and the determining the authentication may be based at least in part on the biometric identifier.

In some embodiments, the determining of the authentication may be based at least in part on an output of a pretrained machine-learning model or a pretrained neural network.

Moreover, the computer may link an identity of the authenticated individual to a virtual object or an attribute obtained in an environment of the video game. In some embodiments, the identity may be transferrable to a third party or another individual. Note that the attribute may include: a skill, or an achievement. Moreover, the identity may be immutable.

Alternatively or additionally, the computer may link a second identity of the authenticated individual to the game information and/or the second game information. This second identity may be the same as or different from the identity. In some embodiments, the second identity may be transferrable to a third party or another individual. Note that the second identity may be immutable.

In some embodiments of method 500, there may be additional or fewer operations. Furthermore, the order of the operations may be changed, and/or two or more operations may be combined into a single operation.

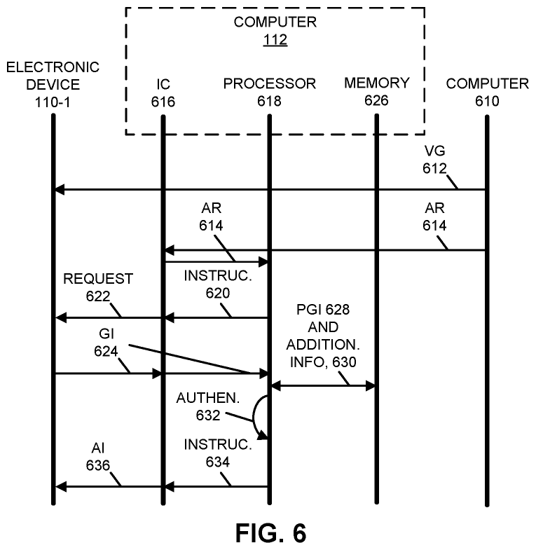

Embodiments of the authentication techniques are further illustrated in FIG. 6, which presents a drawing illustrating an example of communication among computer 112, electronic device 110-1 and computer 610. In FIG. 6, computer 610 provide information specifying a video game (VG) 612 to electronic device 110-1, which is used by an individual associated with electronic device 110-1 to play video game 612. Then, computer 610 may provide, to computer 112, an authentication request (AR) 614 associated with an individual currently playing video game 612. For example, authentication request 614 may be provided after the individual has played video game 612 for a predefined time interval, such as 1, 3, 5 or 10 min.

After receiving authentication request 614, an interface circuit (IC) 616 in computer 112 may provide authentication request 614 to a processor 618 in computer 112. In response, processor 618 may instruct 620 interface circuit 616 to request 622 game information (GI) 624 from electronic device 110-1.

Moreover, after receiving request 622, electronic device 110-1 may provide game information 624 to computer 112. This may involve electronic device 110-1 performing one or more measurements while the individual plays video game 612 on or using electronic device 110-1.

Then, after receiving game information 624, interface circuit 616 may provide game information 624 to processor 618. Furthermore, processor 618 may access, in memory 626 in or associated with computer 112 (and/or in memory associated with computer 610), predetermined game information (PGI) 628 associated with one or more prior instances of play of video game 612 by the individual or additional information 630 associated with video game 612. In some embodiments, processor 618 may access, in memory 626, information associated with one or more pretrained machine-learning models or one or more pretrained neural networks.

Furthermore, processor 618 may determine authentication 632 of the individual based at least in part on game information 624 and predetermined game information 628. For example, processor 618 may compare game information 624 and predetermined game information 628 to determine authentication 632. Notably, processor 618 may compare temporal patterns of game information 624 and predetermined game information 628. Alternatively or additionally, predetermined game information 628 may specify a baseline (such as a mean and a standard deviation in a given decision or behavior), and game information 624 may be evaluated for its statistical significance (such as a p-value) relative to the baseline. If game information 624 is similar to predetermined game information 628 (e.g., within three standard deviations of a mean), processor 618 may determine that the individual should be authenticated. In some embodiments, processor 618 may compute a vector product of game information 624 and predetermined game information 628, and may selectively authenticate the individual based at least in part on the resulting direction cosine(s) (such as when a sum of the direction cosine(s) exceeds a predefined value). More generally, processor 618 may use game information 624 and predetermined game information 628 as inputs to one or more pretrained machine-learning models or one or more pretrained neural networks, which may provide output(s) that specify authentication 632. Note that authentication 632 may be categorical (such as binary-valued) or real-valued.

Next, processor 618 may selectively instruct 634 interface circuit 616 to provide allowance information (AI) 636 to computer 610. This allowance information may inform computer 610 that the individual is allowed to continue to play video game 612 based at least in part on authentication 632. Processor 618 may provide this instruction to interface circuit 616 (and, thus, computer 112 may selectively provide allowance information 636) based at least in part on authentication 632. For example, allowance information 636 may be provided when authentication 632 is a ‘1’ (instead of a ‘0’) or has a value greater than a predefined value (such as 80, 90 or 95%).

While FIG. 6 illustrates communication between components using unidirectional or bidirectional communication with lines having single arrows or double arrows, in general the communication in a given operation in this figure may involve unidirectional or bidirectional communication.

We now further describe embodiments of the authentication techniques. Many existing authentication techniques for video-game tournaments are inadequate. Consequently, boosting and account sharing is rampant. Moreover, users can collude to change tournament results, and underage users are able to illegally access the tournaments. These challenges expose video-game developers or publishers, tournament operators and tournament hosts to liability for potential fraudulent activity.

In order to address these problems, the authentication techniques may be used to accurate authentical individuals and to tie them to their virtual identities in video games. For example, a single electronic device (such as a cellular telephone) may be assigned to or associated with a single individual for authentication. Notably, the individual may pre-register with an authentication system that may: verify the identity of an individual; determine eligibility to play a video game (such as in a tournament); and/or maintained an immutable record of scholastic results, gameplay and/or behavior in a data structure, such as a ledger. This pre-registration may include: providing an identifier of the electronic device; performing one or more authentication techniques; and providing an image of a government-issued identification.

Subsequently, an individual may log into the authentication system (e.g., using a gamer tag instead of a password). In response, a secure message may be sent to their electronic device to approve or deny authentication request. Note that authentication attempts may be logged in the immutable record. The logged information may include a video game or a website that hosts a video game for which the individual attempted authentication, a physical location of the electronic device during the authentication (such as a latitude and a longitude), and their associated identity verification (or lack of verification).

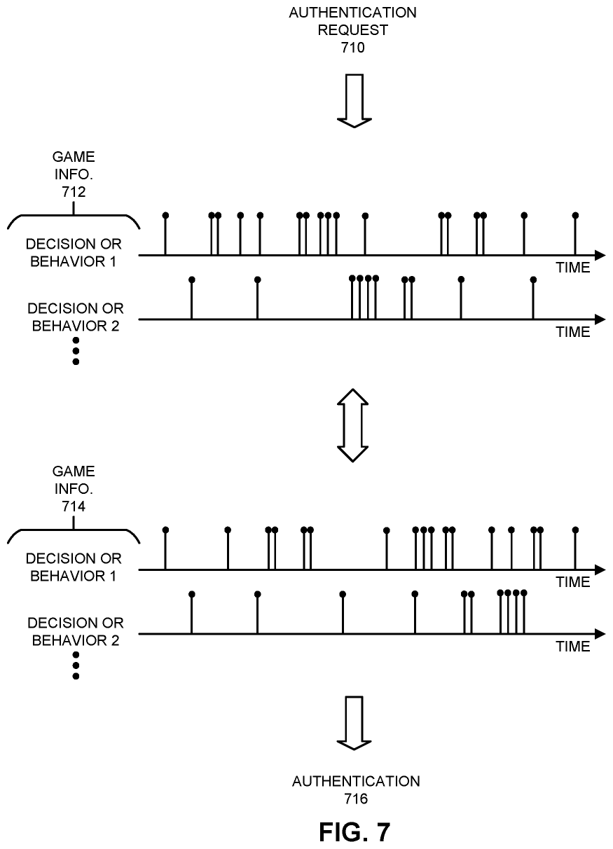

Alternatively or additionally, the individual may, at least in part, be authenticated using the authentication technique. This is shown in FIG. 7, which presents a drawing illustrating an example of performing authentication of an individual in accordance with an embodiment of the present disclosure. Notably, a computer may receive an authentication request 710 associated with an individual playing a video game. In response to authentication request 710, the computer may obtain game information 712 associated with current play of the video game by the individual and game information 714 associated with one or more prior instances of the individual playing the video game. For example, game information 712 and game information 714 may include temporal patterns of decisions and behaviors of the individual while playing the video game. Then, the computer may determine authentication 716 of the individual based at least in part on game information 712 and game information 714. Next, the computer may selectively allow the individual to continue to play the video game based at least in part on authentication 716.

As discussed previously, in the recommendation techniques and/or the authentication techniques, the computer may use one or more pretrained machine-learning models and/or one or more pretrained neural networks. Notably, the computer may use a pretrained classifier or regression model, which may be trained using a supervised learning technique and/or an unsupervised learning technique) and a training dataset with a history of one or more individuals' previous decisions and behavior when playing one or more video games to selectively make recommendations or to authenticate an individual. For example, a given pretrained machine-learning model may include a classifier or a regression model that was trained using: a support vector machine technique, a classification and regression tree technique, logistic regression, LASSO, linear regression, and/or another linear or nonlinear supervised-learning technique. Moreover, a given pretrained neural network may include a convolutional neural network, a generative adversarial network or another type of neural network. During operation, the given pretrained machine-learning model or the given pretrained neural network may use attributes or characteristics of an individual (such as attributes or characteristics that specify or that are associated with the decisions or behaviors of the individual) as inputs, and may output one or more recommendations and/or may provide authentication of the individual.

In some embodiments the given pretrained neural network may include convolutional blocks, arranged sequentially, followed by a softmax layer. For example, a large convolutional neural network may include, e.g., 60 M parameters and 650,000 neurons. The convolutional neural network may include, e.g., eight learned layers with weights, including, e.g., five convolutional layers and three fully connected layers with a final 1000-way softmax or normalized exponential function that produces a distribution over the 1000 class labels. Some of the convolution layers may be followed by max-pooling layers. In order to make training faster, the convolutional neural network may use non-saturating neurons (such as a local response normalization) and an efficient dual parallelized graphical processing unit (GPU) implementation of the convolution operation. In addition, in order to reduce overfitting in the fully-connected layers, a regularization technique (which is sometimes referred to as ‘dropout’) may be used. In dropout, the predictions of different models are efficiently combined to reduce test errors. In particular, the output of each hidden neuron is set to zero with a probability of 0.5. The neurons that are ‘dropped out’ in this way do not contribute to the forward pass and do not participate in backpropagation. Note that the convolutional neural network may maximize the multinomial logistic regression objective, which may be equivalent to maximizing the average across training cases of the log-probability of the correct label under the prediction distribution.

In some embodiments, the kernels of the second, fourth, and fifth convolutional layers are coupled to those kernel maps in the previous layer that reside on the same GPU. The kernels of the third convolutional layer may be coupled to all kernel maps in the second layer. Moreover, the neurons in the fully connected layers may be coupled to all neurons in the previous layer. Furthermore, response-normalization layers may follow the first and second convolutional layers, and max-pooling layers may follow both response-normalization layers as well as the fifth convolutional layer. A nonlinear model of neurons, such as Rectified Linear Units, may be applied to the output of every convolutional and fully-connected layer.

In some embodiments, the first convolutional layer filters, e.g., a 224×224×3 input file with 96 kernels of size 11×11×3 with a stride of four pixels (this is the distance between the receptive field centers of neighboring neurons in a kernel map). Note that the second convolutional layer may take as input the (response-normalized and pooled) output of the first convolutional layer and may filter it with, e.g., 256 kernels of size 5×5×48. Furthermore, the third, fourth, and fifth convolutional layers may be coupled to one another without any intervening pooling or normalization layers. The third convolutional layer may have, e.g., 384 kernels of size 3×3×256 coupled to the (normalized, pooled) outputs of the second convolutional layer. Additionally, the fourth convolutional layer may have, e.g., 384 kernels of size 3×3×192, and the fifth convolutional layer may have 256 kernels of size 3×3×192. The fully-connected layers may have, e.g., 4096 neurons each. Note that the numerical values in the preceding and the remaining discussion below are for purposes of illustration only, and different values may be used in other embodiments.

In some embodiments, the convolutional neural network is implemented using at least two GPUs. One GPU may run some of the layer parts while the other runs the remaining layer parts, and the GPUs may communicate at certain layers. The input of the convolutional neural network may be, e.g., 150,528-dimensional, and the number of neurons in the remaining layers in the convolutional neural network may be given by, e.g., 253, 440-186, 624-64, 896-64, 896-43, and 264-4096-4096-1000.

While the preceding discussion illustrated the recommendation techniques and the authentication techniques as a service this provided to an individual or to game platform (such as a developer or a provider of a video game), in other embodiments the recommendation techniques and/or the authentication techniques may be provided to a third party. For example, the recommendation techniques may be provided to an organization that the individual is associated with (such as a company, a college, a university, a secondary or higher educational institution, a non-profit company, a government agency, etc.). Moreover, the authentication techniques may be provided to a provider of an environment in which a video game is played (such as a provider of an environment in which multiple different video games from different developers can be played, e.g., an online gaming platform or a real-time multi-player gaming platform). Consequently, in other embodiments, the customer for the recommendation techniques and the authentication techniques may not be the individual or the developer of a particular video game.

We now describe embodiments of an electronic device, which may perform at least some of the operations in the recommendation techniques and the authentication techniques. FIG. 8 presents a block diagram illustrating an example of an electronic device 800 in accordance with some embodiments. For example, electronic device may include: electronic device 110-1, computer 112, access point 116-1, or one of radio nodes 118. This electronic device may include processing subsystem 810, memory subsystem 812, and networking subsystem 814. Processing subsystem 810 includes one or more devices configured to perform computational operations. For example, processing subsystem 810 can include one or more microprocessors, ASICs, microcontrollers, programmable-logic devices, GPUs and/or one or more digital signal processors (DSPs). Note that a given component in processing subsystem 810 are sometimes referred to as a ‘computational device.’

Memory subsystem 812 includes one or more devices for storing data and/or instructions for processing subsystem 810 and networking subsystem 814. For example, memory subsystem 812 can include dynamic random access memory (DRAM), static random access memory (SRAM), and/or other types of memory. In some embodiments, instructions for processing subsystem 810 in memory subsystem 812 include: program instructions or sets of instructions (such as program instructions 822 or operating system 824), which may be executed by processing subsystem 810. Note that the one or more computer programs or program instructions may constitute a computer-program mechanism. Moreover, instructions in the various program instructions in memory subsystem 812 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 810.

In addition, memory subsystem 812 can include mechanisms for controlling access to the memory. In some embodiments, memory subsystem 812 includes a memory hierarchy that comprises one or more caches coupled to a memory in electronic device 800. In some of these embodiments, one or more of the caches is located in processing subsystem 810.

In some embodiments, memory subsystem 812 is coupled to one or more high-capacity mass-storage devices (not shown). For example, memory subsystem 812 can be coupled to a magnetic or optical drive, a solid-state drive, or another type of mass-storage device. In these embodiments, memory subsystem 812 can be used by electronic device 800 as fast-access storage for often-used data, while the mass-storage device is used to store less frequently used data.

Networking subsystem 814 includes one or more devices configured to couple to and communicate on a wired and/or wireless network (i.e., to perform network operations), including: control logic 816, an interface circuit 818 and one or more antennas 820 (or antenna elements). (While FIG. 8 includes one or more antennas 820, in some embodiments electronic device 800 includes one or more nodes, such as antenna nodes 808, e.g., a metal pad or a connector, which can be coupled to the one or more antennas 820, or nodes 806, which can be coupled to a wired or optical connection or link. Thus, electronic device 800 may or may not include the one or more antennas 820. Note that the one or more nodes 806 and/or antenna nodes 808 may constitute input(s) to and/or output(s) from electronic device 800.) For example, networking subsystem 814 can include a Bluetooth™ networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, and/or another networking system.

Networking subsystem 814 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 800 may use the mechanisms in networking subsystem 814 for performing simple wireless communication between the electronic devices, e.g., transmitting advertising or beacon frames and/or scanning for advertising frames transmitted by other electronic devices as described previously.

Within electronic device 800, processing subsystem 810, memory subsystem 812, and networking subsystem 814 are coupled together using bus 828. Bus 828 may include an electrical, optical, and/or electro-optical connection that the subsystems can use to communicate commands and data among one another. Although only one bus 828 is shown for clarity, different embodiments can include a different number or configuration of electrical, optical, and/or electro-optical connections among the subsystems.

In some embodiments, electronic device 800 includes a display subsystem 826 for displaying information on a display, which may include a display driver and the display, such as a liquid-crystal display, a multi-touch touchscreen, etc.

Moreover, electronic device 800 may include a user-interface subsystem 830, such as: a mouse, a keyboard, a trackpad, a stylus, a voice-recognition interface, and/or another human-machine interface. In some embodiments, user-interface subsystem 830 may include or may interact with a touch-sensitive display in display subsystem 826.

Electronic device 800 can be (or can be included in) any electronic device with at least one network interface. For example, electronic device 800 can be (or can be included in): a desktop computer, a laptop computer, a subnotebook/netbook, a server, a tablet computer, a smartphone, a cellular telephone, a smartwatch, a consumer-electronic device, a portable computing device, an access point, a transceiver, a radio node, a router, a switch, communication equipment, an access point, a controller, test equipment, and/or another electronic device.

Although specific components are used to describe electronic device 800, in alternative embodiments, different components and/or subsystems may be present in electronic device 800. For example, electronic device 800 may include one or more additional processing subsystems, memory subsystems, networking subsystems, and/or display subsystems. Additionally, one or more of the subsystems may not be present in electronic device 800. Moreover, in some embodiments, electronic device 800 may include one or more additional subsystems that are not shown in FIG. 8. Also, although separate subsystems are shown in FIG. 8, in some embodiments some or all of a given subsystem or component can be integrated into one or more of the other subsystems or component(s) in electronic device 800. For example, in some embodiments program instructions 822 are included in operating system 824 and/or control logic 816 is included in interface circuit 818.

Moreover, the circuits and components in electronic device 800 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 814 and/or electronic device 800. The integrated circuit may include hardware and/or software mechanisms that are used for transmitting wireless signals from electronic device 800 and receiving signals at electronic device 800 from other electronic devices. Aside from the mechanisms herein described, radios are generally known in the art and hence are not described in detail. In general, networking subsystem 814 and/or the integrated circuit can include any number of radios. Note that the radios in multiple-radio embodiments function in a similar way to the described single-radio embodiments.

In some embodiments, networking subsystem 814 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used an Ethernet, a cellular-telephone communication protocol (such as LTE) and/or a Wi-Fi communication protocol as an illustrative example, in other embodiments a wide variety of communication protocols and, more generally, wireless communication techniques may be used. For example, the communication protocol in a WLAN may use OFDMA. Thus, the recommendation techniques and the authentication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the recommendation techniques and the authentication techniques may be implemented using program instructions 822, operating system 824 (such as a driver for interface circuit 818) or in firmware in interface circuit 818. Thus, the recommendation techniques and the authentication techniques may be implemented at runtime of program instructions 822. Alternatively or additionally, at least some of the operations in the recommendation techniques and the authentication techniques may be implemented in a physical layer, such as hardware in interface circuit 818.

In the preceding description, we refer to ‘some embodiments.’ Note that ‘some embodiments’ describes a subset of all of the possible embodiments, but does not always specify the same subset of embodiments. Moreover, note that the numerical values provided are intended as illustrations of the recommendation techniques and the authentication techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer, comprising:
an interface circuit configured to communicate with an electronic device;
a processor coupled to the interface circuit;
memory, coupled to the processor, configured to store program instructions, wherein, when executed by the processor, the program instructions cause the computer to perform operations comprising:
receiving an authentication request associated with an individual playing a video game;
in response to the authentication request, obtaining game information associated with current play of the video game by the individual and second game information associated with one or more prior instances of the individual playing the video game;
determining authentication of the individual based at least in part on the game information and the second game information; and
selectively allowing the individual to continue to play the video game based at least in part on the authentication.

2. The computer of claim 1, wherein the determining of the authentication is based at least in part on a location of an electronic device associated with the individual.

3. The computer of claim 1, wherein the authentication request comprises an identifier of an electronic device associated with the individual and the determining of the authentication is based at least in part on the identifier.

4. The computer of claim 3, wherein the identifier comprises a media access control (MAC) address or an Internet Protocol (IP) address.

5. The computer of claim 1, wherein the authentication request comprises an encrypted value associated with the individual and the determining of the authentication is based at least in part on the encrypted value.

6. The computer of claim 5, wherein the encrypted value is based at least in part on a predefined alphanumeric value.

7. The computer of claim 6, wherein the predefined alphanumeric value comprises a random number or a pseudorandom number.

8. The computer of claim 5, wherein the authentication request comprises an alphanumeric value and the encrypted value corresponds to the alphanumeric value;
wherein the operations comprise:
calculating a second encrypted value based at least in part on the alphanumerical value and a predefined encryption key associated with the individual; and
comparing the encrypted value and the second encrypted value; and
wherein the determining of the authentication is based at least in part on the comparison.

9. The computer of claim 1, wherein the authentication request comprises a biometric identifier of the individual and the determining of the authentication is based at least in part on the biometric identifier.

10. The computer of claim 1, wherein the game information and the second game information specify decisions and behaviors of the individual in the video game while the individual is playing or played the video game.

11. The computer of claim 1, wherein the game information and the second game information specify interactions in the video game with another player while the individual and the other player play or played the video game.

12. The computer of claim 1, wherein the game information and the second game information comprise monitoring data of the individual while the individual is playing or played the video game; and
wherein the monitoring data specifies or comprises at least one of: physiological data of the individual, a gaze direction of the individual, eye motion of the individual, a posture of the individual, fidgeting of the individual, user-interface actions of the individual, or a type of facial expression of the individual.

13. The computer of claim 1, wherein the determining of the authentication is based at least in part on an output of a pretrained machine-learning model or a pretrained neural network.

14. The computer of claim 1, wherein the operations comprise linking an identity of the authenticated individual to a virtual object or an attribute obtained in an environment of the video game.

15. The computer of claim 14, wherein the attribute comprises: a skill, or an achievement.

16. The computer of claim 14, wherein the identity is immutable.

17. The computer of claim 1, wherein the operations comprise linking an identity of the authenticated individual to the game information, the second game information, or both.

18. The computer of claim 17, wherein the identity is immutable.

19. A non-transitory computer-readable storage medium for use in conjunction with a computer, the computer-readable storage medium configured to store program instructions that, when executed by the computer, causes the computer to perform operations comprising:
receiving an authentication request associated with an individual playing a video game;
in response to the authentication request, obtaining game information associated with current play of the video game by the individual and second game information associated with one or more prior instances of the individual playing the video game;
determining authentication of the individual based at least in part on the game information and the second game information; and
selectively allowing the individual to continue to play the video game based at least in part on the authentication.

20. A method for performing authentication, comprising:
by a computer:
receiving an authentication request associated with an individual playing a video game;
in response to the authentication request, obtaining game information associated with current play of the video game by the individual and second game information associated with one or more prior instances of the individual playing the video game;
determining authentication of the individual based at least in part on the game information and the second game information; and
selectively allowing the individual to continue to play the video game based at least in part on the authentication.
